(19) United States
(12) Patent Application Publication
(10) Pub. No.: US 2017/0179854 A1
(43) Pub. Date: Jun. 22, 2017

(54) MOTOR ON-DELAY TIMER

(71) Applicant: SCHNEIDER ELECTRIC USA, INC., Schaumburg, IL (US)

(72) Inventors: Alan E. Freeman, Raleigh, NC (US); Kevin M. Jefferies, Raleigh, NC (US); Benjamin W. Edwards, Rolesville, NC (US); Matthew L. White, Raleigh, NC (US); Konstantin Alexander Filippenko, Grenoble (FR); Richard Karl Weiler, Wake Forest, NC (US)

(73) Assignee: SCHNEIDER ELETRIC USA, INC., Schaumburg, IL (US)

(21) Appl. No.: 14/976,191

(22) Filed: Dec. 21, 2015

(51) Int. Cl. H02P 1/56; H05B 37/02; H02P 1/58

(52) U.S. Cl. CPC H02P 1/56; H02P 1/58; H05B 37/0227

(57) ABSTRACT

A load starting system in which an upstream controller determines the sequence and timing for starting a group of loads in the most efficient and timely manner. The sequence and timing is determined by one or more real-time operational characteristics, device rating characteristics, customer/user characteristics or learned/historic characteristics or by a combination of the one or more real-time, device rating, customer/user or learned/historic characteristic.

### FIELD OF THE INVENTION

The invention is generally directed to motor control and particularly to the starting or restarting of multiple motors in the least amount of time.

### BACKGROUND OF THE INVENTION

When a motor starts it has a high inrush current, which can cause problems with upstream equipment such as transformers, power supplies, and circuit breakers. With several motors trying to start at the same time the inrush problem is much greater. It has been common practice to incorporate a time delay between each motor starting to reduce the high inrush problem, which can significantly increase the time it takes for all motors to come online. Increasing the current carrying capacity of upstream equipment can reduce start-up time but it can also significantly increase cost. Therefore, it would be desirable to minimize the start-up time while keeping the upstream equipment sized as close to the total run-time current capacities as possible.

### SUMMARY OF THE INVENTION

By intelligently selecting the order and timing of the load start sequence it is possible to optimize system start-up time, engaging all loads as quickly as possible while respecting defined system constraints. The benefits include quicker total system on-time, ability to optimize upstream distribution system size (circuit breaker, transformers, power supplies) to total load running currents instead of load inrush currents, and the potential to expand the system without the need to modify timers and circuit breaker settings.

The present invention provides a method for starting multiple loads in a most efficient and timely manner comprising the steps of:
comparing, by a processor, all loads to be started with a threshold characteristic;
selecting, by the processor, from all loads to be started, one or more loads that can be started without exceeding the threshold characteristic;
starting, by a starter, the one or more selected loads; and
repeating the comparing, selecting and starting until all remaining loads have been started.

### BRIEF DESCRIPTION OF THE DRAWINGS

FIG. 1 illustrates a system of the present invention for efficiently and rapidly controlling the startup of multiple high inrush loads by an upstream controller.

FIG. 2 is a flow chart for the basic steps required for the upstream controller to start multiple loads in the shortest amount of time without exposing upstream protection equipment/power supplies to currents exceeding a threshold.

FIG. 3 is a graphical representation or several loads starting sequentially.

FIG. 4 is an inrush curve of four loads starting.

### DETAILED DESCRIPTION OF THE EXAMPLE EMBODIMENTS

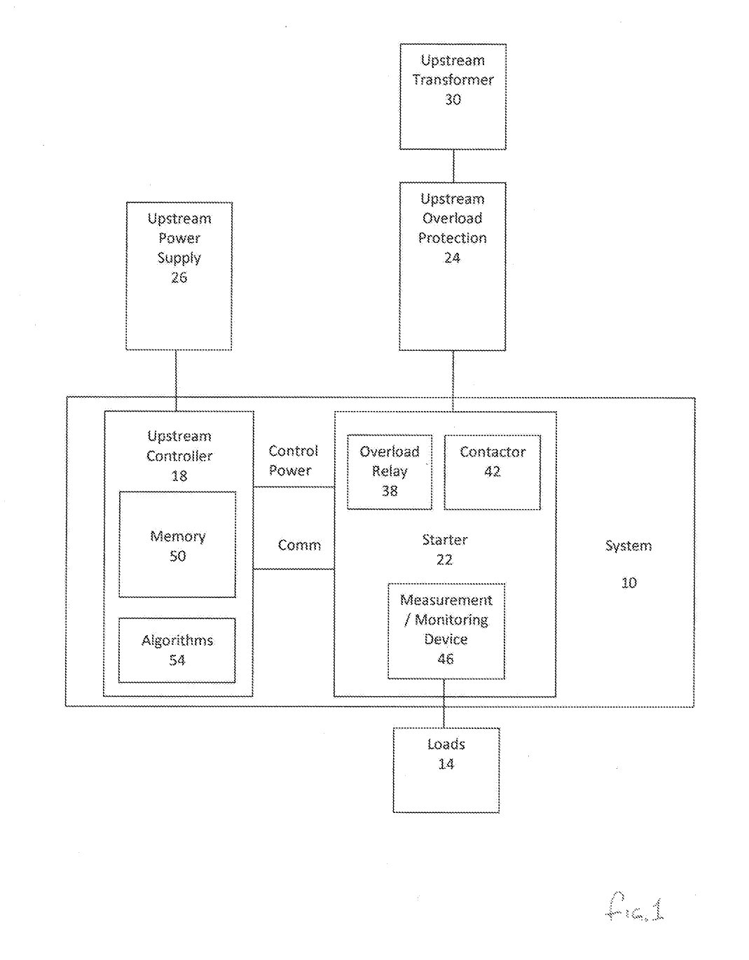

FIG. 1 illustrates a system, generally indicated by reference numeral 10, for sequentially and/or simultaneously starting or re-starting a group of loads 14 as specified by a customer for a given application or in the shortest time possible while not exceeding a threshold based on one or more particular characteristics of each load 14 or of the sum of the particular characteristics for all loads 14 being connected. The system 10 includes an upstream controller 18, which controls a group of starters 22, each of which is associated with at least one load 14. The loads 14 at issue in this disclosure are generally associated with high startup inrush currents, such as motors and lighting systems but could be any application where multiple loads 14 are required to start in rapid succession. Some applications of the invention discussed below will be relevant only to electric motors, in those applications the term “motor load 14” will be used. Other upstream devices in the system 10 that can be affected by high inrush currents are power supplies 26, transformers 30 and protective devices 34 such as a circuit breaker, which are generally sized to accommodate the total full load current (FLC) of all loads 14 in the system 10 plus an inrush safety factor which can be determined by the upstream devices, local standards and/or design constraints. Each starter 22 has an overload relay 38 for protecting its associated load 14, a contactor 42 for turning its associated load 14 ON and OFF and a measurement and/or circuit parameter detection means 46. Each starter 22 has a unique ID in the upstream controller 18, under which all data collected from customer/user inputs, real-time operational data and historic data learned from previous activity of the starter's 22 associated load 14 can be stored in a memory 50 of the upstream controller 18.

Examples of customer/user inputs include load 14 application information, subsets of loads 14 that must always be started together (e.g. conveyor belts), load 14 priorities (for example, loads 14 that are required to start in a specific sequence in a given application), load 14 rating inputs, load warm-up/re-strike time per manufacturer's recommendations (e.g. lighting applications), load 14 characteristics (generic “HID light” vs “IE3 motor” vs. “IE1 motor” to differentiate expected inrush current peak), transformer 30 inrush ratings, circuit breaker 26 trip settings and overload relay 38 trip classes. The customer/user input information is entered into the upstream controller 18 as a configuration file.

Examples of real-time operational inputs include current, voltage (bus, starter), FLC settings, load 14 off-time, load 14 on-time and the thermal memory of each starter 22. The real-time operational inputs can be obtained by using current or voltage sensors, timers, and aggregation of this current, voltage, and timing information, for instance, current and time information could be collected and stored as an inrush curve for a given starting sequence.

The learned historical inputs are a sum or average of many instances of “real-time operational data” over a large period of time. This data, which is available in real-time in the upstream controller 18, can be aggregated and analyzed by embedded software into graphical representation such as a load 14 inrush curve, which is a range of expected peak currents and the duration of the peak currents. A maximum or average inrush curve can be used by the upstream controller 18 to characterize each motor load 14 in any of the algorithms disclosed herein.

The upstream controller 18 uses the various sources and information described above to make decisions on the starting sequence and start timing which will be the most efficient electrically and require the least amount of time while meeting any predetermined requirements of the system 10. A system 10, as generally described above, can be operated using one of several algorithms 54 discussed below depending on the type of inputs given to the upstream controller 18.

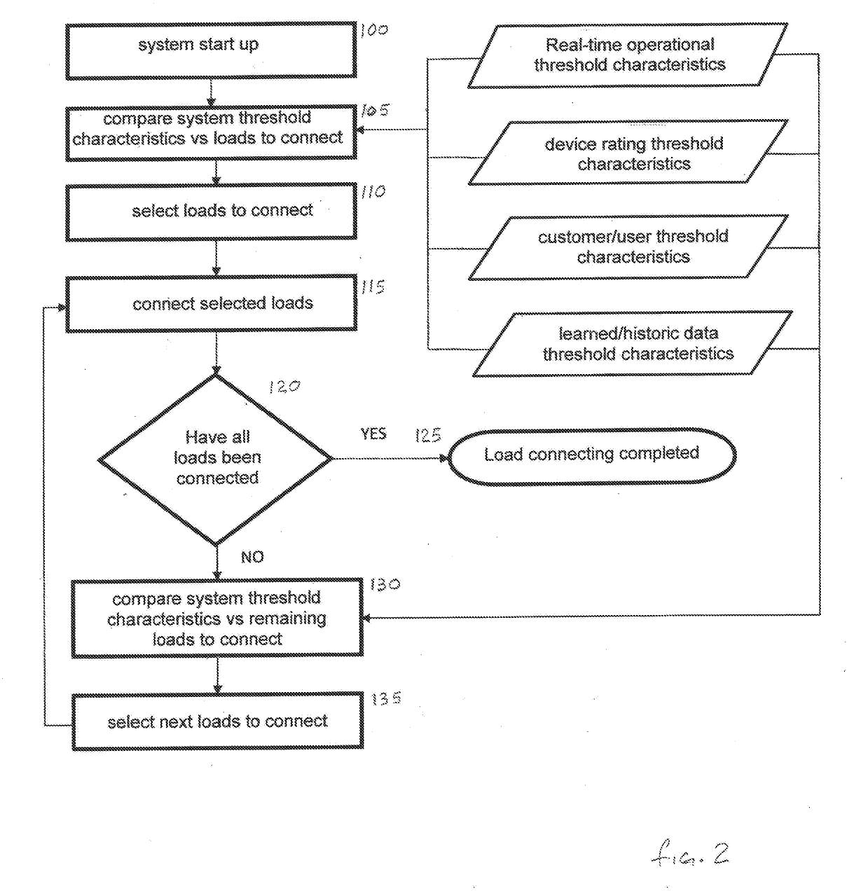

FIG. 2 is a flow chart showing the basic steps of the method for starting a group of loads 14 according to present invention. At step 100 the controller 18 initiates the algorithm 54 for selecting and starting the loads 14. At step 105 the controller 18 compares the particular threshold characteristic with the particular characteristic of the loads 14 available for connection. At step 110 the controller 18 selects one or more loads 14 that meet the threshold characteristic requirement from the loads 14 available for connecting. At step 115 the controller connects the selected load 14. At step 120 the controller 18 checks to see if the last load 14 has been connected. If the last load 14 has been connected the controller 18 proceeds to step 125, if not the controller 18 proceeds to step 130, where the particular characteristic of the remaining loads 14 to be connected are compared with the particular threshold characteristic. At step 135, the next loads 14 to be connected are selected. The controller 18 proceeds to step 115 where the selected loads 14 are connected. The cycle of steps 120, 130, 135 and 115 continues until all of the loads 14 to be connected have been connected.

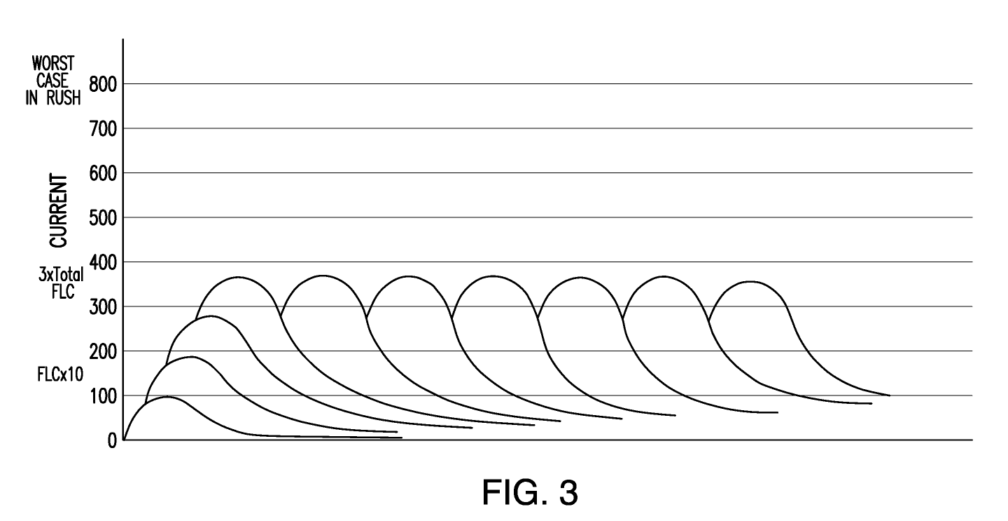

Referring now to FIG. 3, a graphic illustration of 10 loads 14 (in this example the loads 14 are motors) being started sequentially. In this basic example of the invention, which monitors the total current drawn by the system 10 in real-time and compares it to a threshold based on the total full load current (FLC) of all loads 14 being started. In this example a group of 10 motors are to be started, each motor having a FLC of 10 amps for a total FLC of 100 amps and a worst case inrush current of 800-1500 amps when all 10 motors are started simultaneously. A threshold which is high enough to permit several motors to start in rapid sequence but low enough to prevent problems with upstream equipment such as transformers, power supplies, and circuit breakers sized for inrush currents above the total FLC is desirable. Therefore, a threshold of 3× total FLC (300 amps) is selected for this example. Using the method described in FIG. 2, the controller 18 starts the first four motor loads 14 in rapid sequence by repeating steps 115, 120, 130 and 135, and each of the remaining six motors with a short delay at step 130 until the monitored real-time current drops below the 3× total FLA threshold. This algorithm 54 can be improved with knowledge of historical mean inrush curves associated with each load 14 that would allow the controller 18 to anticipate the total current likely reached by the addition of a new load 10 instead of adding loads 10 and measuring real-time currents. This would permit the selection of a higher threshold value resulting in faster starting of the remaining loads 14.

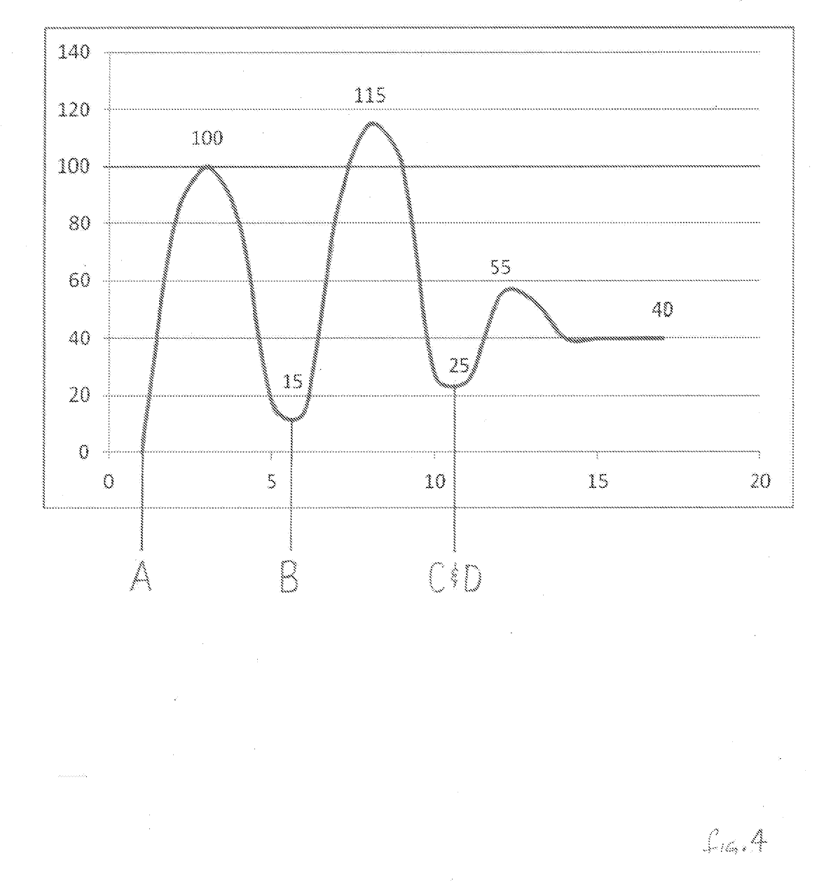

Individual starters 22 can control substantially different loads 14. The controller 18 can read from memory 50 previously learned historical inrush current and duration data and determine which loads 14 have low inrush peaks (drives, soft starters, etc) as well as determine the typical duration of their inrush current. With this learned data the controller 18 can define a group of loads 14 with low inrush currents that could all be started at once without the need for a timing delay. Similarly the controller 18 can determine which loads 14 have high or long peak inrush currents and anticipate their affect on the system 10, staggering their starts times for a longer than normal time or ensuring that these loads 14 start when there is a minimal current load on the system 10, thus minimizing peak system inrush current. An example is given below in table 1 and shown graphically in FIG. 4, where loads 14 (A and B) with large inrush currents are started first, with a delay between them, on an unloaded system 10 (to minimize total current on the system 10 at any given time) and the other loads 14 (C and D) are combined and started last since their total inrush currents have very little impact on the total inrush current of system 10. The algorithm 54 for this embodiment would include the following steps:
Acquiring, from an upstream controller 18, data representing a typical inrush peak and a typical inrush duration for each starter 22;
deriving, from the typical inrush peak and the typical inrush duration data, an inrush curve for each starter;
arranging, the inrush curves in groups of low vs. high inrush peak and duration;
determining a starting and a timing sequence beginning with a load 14 having the highest inrush, followed by each subsequent “high inrush” load 14 as soon as the previous inrush current has diminished; and
combining any “low-inrush” loads 14 into a group for starting simultaneously.

TABLE 1

| | FLC | Inrush Current |
|---|---|---|
| Load A | 10 A | 100 A |
| Load B | 10 A | 100 A |
| Load C | 10 A | 15 A |
| Load D | 10 A | 15 A |

Maintaining a minimum voltage in the system 10 is critical to ensure continuous operation of the system 10. The upstream controller 18 will have control voltage as an input and will know the control voltage value at any given time. Each time a starter 22 is connected the voltage supplying the collection of starter 22 coils will dip during inrush. If the monitored voltage drops below a threshold the upstream controller 18 could delay the connection of an additional load 14. The upstream controller 18 will also have the ability to store in memory 50 historical control voltage changes based on connection of additional starters 22. The upstream controller 18 will be able to store an expected voltage dip for the “nth” starter 22 connected. Thus, a refinement of the threshold can be done based on historical knowledge of the magnitude of voltage dips for individual starters 22.

In motor load 14 applications, when a short power loss occurs in the system 10 the upstream controller 18 can begin to re-start the motor loads 14 as soon as power is restored to the system 10. Any motor loads 14 that are still rotating freely can be turned ON immediately with minimal inrush current being added to the system 10. This phenomenon can be used to re- categorize expected motor inrush curves based on the length of time since they were switched off. For example, if power to the system 10 was off for less than 1 second the expected motor load 14 inrush currents might be re-categorized to a lower level (e.g. a motor load 14 expected to have an inrush current of 8×FLC might be re-categorized to a motor load 14 having an inrush current of 2×FLC).

If the power has been off for more than 1 second the upstream controller 18 can analyze historic instances where the starter 22 had a lower peak inrush current than historically. The upstream controller 18 then determines if the lower peak inrush current is based on how long the starter's 22 motor load 14 was disconnected. When it is applicable, the upstream controller 18 stores in memory 50 the “inrush value” for that starter ID as a dynamic function of time, not as a fixed peak value. This inrush value is then used in determining starting sequence and timing.

The peak inrush can also be assumed (based on customer categorization of motor load 14 type) or learned (based on historical inrush curves for starting that motor load 14 after short off-periods). This can be improved over time by calculation of a learned/typical time constant for the braking of the motor rotor. Expected inrush can be stored in the upstream controller 18 memory 50 under the starter's 22 ID and fit to an exponential curve inrush peak as a function of a learned time constant (per motor load 14) and time.

Through frequent reporting of motor load 14 status on a communication bus of system 10, the upstream controller 18 will know the thermal memory of each starter 22. A motor thermal model based on current and time is also stored in memory 50 of the upstream controller 18 as a way to determine the motor load 14 thermal state for overload protection. In the absence of any other starting priorities, the upstream controller 18 can assign dynamic starting priorities based on “coldest-first” in order to give the “hotter” motor loads 14/starters 22 extra time to cool down. The upstream controller 18 can take the starter's 22 last stored thermal state minus a decay factor based on the length of time since the measurement was taken (the last time the starter 22 was on). For example, in Table 2 below starter 22 B has a calculated thermal state of 0% and is therefore the coldest motor load 14 and first to be started. Starter 22 E, at 8% calculated thermal state is the next to start with D at 10%, C at 32% and A at 85% following in that order.

TABLE 2

| | Thermal | | |
|---|---|---|---|
| | state at last | | Calculated |
| starter | <OFF> | OFF time | thermal state |
| Starter A | 90% ‘full’ | 0.5 sec | 85% |
| Starter B | 70% | 20 min | 0% |
| Starter C | 40% | 1 sec | 32% |
| Starter D | 40% | 1 min | 10% |
| Starter E | 10% | 1 sec | 8% |

As in the previous algorithm 54, the upstream controller 18 will know the thermal memory of each starter 22 in the system 10. The upstream controller 18 could monitor this over time and store in memory 50 an expected value for the rise in thermal state due to inrush for each starter 22 in the system 10. For example a given motor load 14 can have a high current inrush and will typically heat up to 30% of its thermal capacity during inrush. This expected inrush current can be stored in memory 50 of the upstream controller 18. If the upstream controller 18, using the stored expected inrush current, determines with a high degree of probability that “hot-starting” a particular motor load 14 would cause it to exceed its thermal capacity and trip its overload relay 38, the start signal could be modified/delayed until the “at-risk” motor load 14 has had time to cool. The upstream controller 18 can make the decision to either simply delay starting the “at risk” motor load 14 (if the sequence of motor load 14 starting is critical) or to start some other motor loads 14 first (if the timing of motor load 14 starting is critical). For instance in starter 22 A above, the thermal status was at 90% “full”. If this controlled the load 14 with a large inrush (adding 30% to thermal capacity during inrush) then the large inrush will likely push the starter's 22 overload relay 38 to trip if it is restarted after just 0.5s. Delaying all starters 22 a few seconds or starting other starters 22 prior to starter 22 A will allow the motor load 14 controlled by starter 22 A to cool enough to start and operate without issue. The novelty in this case is the ability to respect the constraints of the upstream controller 18 as a whole (starting sequence vs. starting time) while reducing the risk of causing an overload relay 38 tripping condition.

The load starting system 10 of the present invention responds to the actual behavior of the system 10, rather than using fixed time delays between load 14 starts, as implemented in simple timer starting systems. The starting system 10 can automatically adjust to the presence of new loads 14 in the system 10, or to loads 14 being removed, not selected for starting or prevented from starting. The load starting system 10 can be configured to respect limits such as system capacity, rather than time based limits for starting loads 14 to increase the efficiency of starting the system 10.

Although specific example embodiments of the invention have been disclosed, persons of skill in the art will appreciate that changes may be made to the details described for the specific example embodiments, without departing from the spirit and the scope of the invention.

We claim:

1. A method for starting multiple loads in a most efficient and timely manner comprising the steps of:
comparing, by a processor, all loads to be started with a threshold characteristic;
selecting, by the processor, from all loads to be started, one or more loads that can be started without exceeding the threshold characteristic;
starting, by a starter, the one or more selected loads; and
repeating the comparing, selecting and starting until all remaining loads have been started.

2. The method of claim 1, wherein the threshold characteristic can be one of or a combination of:
a real-time operational characteristic;
a device rating characteristic;
a customer/user characteristic; or
a learned/historic characteristic.

3. The method of claim 2, wherein the real-time operational characteristics can include:
a current;
a voltage (bus or starter);
a group FLC settings;
an on-time;
an off-time; and
a thermal memory of each starter.

4. The method of claim 2, wherein the device rating characteristic can include:
a lighting warm-up/re-strike time;
a load characteristic (lighting type, load type, etc.) a transformer inrush rating;
a circuit breaker trip setting; or
an overload trip class.

5. The method of claim 2, wherein the customer/user characteristic can include:
a subset of loads that must be started together; or
a load priority sequence.

6. The method of claim 2, wherein the learned/historic characteristic can include:
a load inrush current curve.

7. A method for starting multiple loads in a most efficient and timely manner comprising the steps of:
acquiring from an upstream controller, data representing a typical inrush peak current and a typical inrush duration for each starter;
deriving, from the typical inrush peak current and the typical inrush duration data, an inrush curve for each starter;
arranging, the inrush curves in groups of low vs. high inrush peak and duration;
combining any “low-inrush” loads into a group for starting simultaneously;
determining a starting and a timing sequence beginning with a load having the highest inrush, followed by each subsequent “high inrush” load as soon as the previous inrush current has diminished; and
initiated starting of the loads according to the determined starting and timing sequence.
